(19) United States
(12) Patent Application Publication
(10) Pub. No.: US 2026/0259613 A1
(43) Pub. Date: Sep. 3, 2026

(54) TECHNIQUES FOR PRESSURE-BASED HAPTIC FEEDBACK

(71) Applicant: Oura Health Oy, Oulu (FI)

(72) Inventors: Jonathan Sami Watson, San Diego, CA (US); Chetan Bangalore Chikkamariyappa, Dublin, CA (US); Gary Watts, Oceanside, CA (US); Avinoam Halpern, Escondido, CA (US)

(21) Appl. No.: 19/464,298

(22) Filed: Jan. 29, 2026

Related U.S. Application Data
(60) Provisional application No. 63/751,733, filed on Jan. 30, 2025.

(51) Int. Cl. G06F 3/01

(52) U.S. Cl. CPC G06F 3/016; G06F 3/011

(57) ABSTRACT

Methods, systems, and devices for wireless communications are described. In some cases, a wearable ring device may include a flexible pad positioned at least partially within an aperture in an inner housing and may include one or more magnets attached to the flexible pad, where at least a portion of the flexible pad extends beyond a surface of the inner housing. The wearable ring device may additionally include one or more coils positioned between an outer housing and the flexible pad, where the flexible pad is capable of deforming in a first radial direction in response to a first magnetic force generated between the one or more coils. Conversely, circuitry coupled with the one or more coils may be capable of detecting changes in voltage of the one or more coils in response to the flexible component deforming in a second radial direction, opposite the first radial direction.

### CROSS REFERENCE

The present application for Patent claims the benefit of U.S. Provisional Patent Application No. 63/751,733 by WATSON et al., entitled “TECHNIQUES FOR PRESSURE-BASED HAPTIC FEEDBACK,” filed January 30, 2025, assigned to the assignee hereof, and expressly incorporated by reference herein.

### FIELD OF TECHNOLOGY

The following relates to wearable devices and data processing, including techniques for pressure-based haptic feedback.

### BACKGROUND

Some wearable devices may be configured to provide feedback to users via alerts or other notifications, where the alerts or other notifications may communicate information about the health and well-being of the user, or may communicate operating parameters of the wearable ring device, such as battery information or device settings. The feedback may be provided to the user via various communicative means, such as by using lights, sounds, or vibrations, which may vary in their effectiveness and ease of use or may not be capable of being implemented in some form factors, such as wearable ring devices.

### BRIEF DESCRIPTION OF THE DRAWINGS

FIG. 1 shows an example of a wearable ring device that supports techniques for pressure-based haptic feedback in accordance with aspects of the present disclosure.

FIG. 2 shows an example of a wearable ring device that supports techniques for pressure-based haptic feedback in accordance with aspects of the present disclosure.

FIGS. 3 and 4 illustrate examples of systems that support techniques for pressure-based haptic feedback in accordance with aspects of the present disclosure.

### DETAILED DESCRIPTION

Some wearable devices may be configured to provide feedback to users via alerts or other notifications, where the alerts or other notifications may communicate information about the health and well-being of the user or may communicate operating parameters of the wearable ring device, such as battery information (e.g., a low battery warning) or device settings (e.g., whether payment is enabled), among other information. In some cases, wearable devices may be configured to emit lights, sounds, or vibrations to communicate the feedback to a user of the wearable device. For example, the wearable device may vibrate to indicate an alarm, to provide an activity reminder, or to indicate successful completion of a process, such as a contactless payment process. However, such forms of feedback may suffer from various inefficiencies or shortcomings. For example, some forms of feedback may disrupt an environment of the user, may be an annoyance to the user, may cause discomfort, or may fail to draw attention from the user, among other potential factors. Additionally, or alternatively, some forms of feedback, such as vibration (e.g., haptic vibration), may not be capable of being implemented in some form factors, such as wearable ring devices, due to a smaller size of wearable ring devices (e.g., as compared to a wearable watch device) not being capable of housing a vibration device capable of generating the vibration.

Additionally, or alternatively, sizes of wearable devices, such as wearable ring devices, may be constrained to discrete sizes (e.g., ring sizes), and a finger of a user may be between sizes of the wearable ring device, or a knuckle of the finger may be larger than a portion of the finger in which the wearable ring device is worn, such that the wearable ring device may not fit the finger of the user in a way that enables the wearable ring device to obtain accurate measurements (e.g., may not obtain a good fit). Additionally, or alternatively, some wearable ring devices may support smooth finishes on an inner housing of the wearable ring devices, such that the wearable ring device may rotate around the finger of the user (e.g., throughout the night or during activities in day), which may similarly impact accuracy of measurements collected by the wearable ring device. Conventional wearable ring devices may not support a method of determining how well a wearable ring device fits on the finger of the user, such that the wearable ring device may be incapable of determining an accuracy of measurements collected by the wearable ring device.

Accordingly, techniques described herein support a sensor assembly that is capable of functioning as a pressure sensor and is also capable of generating haptic feedback. For example, a wearable ring device may include an inner housing and an outer housing, and the inner housing may include an aperture (e.g., cutout), where an elastomer pad is positioned at least partially within the aperture. In other words, the elastomer pad may protrude past an inner surface of the wearable ring device such that, when a user is wearing the wearable ring device, the elastomer pad contacts a finger of the user on which the wearable ring device is worn and, in some cases, is compressed by the finger. That is, the finger of the user may exert a first (e.g., compressive) force onto the elastomer pad that causes the elastomer pad to deflect, or deform, in a first direction (e.g., radially outward). The wearable ring device may additionally include one or more magnets (e.g., permanent magnets) embedded in, or otherwise attached to, the elastomer pad and one or more coils positioned between the elastomer pad (e.g., and the one or more magnets) and the outer housing of the wearable ring device, such that an “air gap” may exist between the one or more coils and the one or more magnets. In other words, the one or more magnets may not contact the one or more coils (e.g., at least when the wearable ring device is not being worn).

In some cases, at least a first subset of the one or more coils may function as one or more detector coils (e.g., in a first mode), where circuitry electronically coupled to (e.g., attached to) the one or more detector coils may detect a change in voltage in the one or more coils based on the deflection, or deformation, of the elastomer pad in the first direction. In other words, as described previously, the finger of the user may exert the compressive force onto the elastomer pad that causes the elastomer pad to deflect, or deform, in the first direction, causing the one or more magnets embedded in the elastomer pad to move closer to the one or more coils (e.g., as compared to a default position of the one or more magnets when the wearable ring device is not being worn). Thus, the movement of the one or more magnets towards the one or more coils may cause the change in voltage in the one or more coils that may be detected by the circuitry. In such cases, the change in voltage may correlate to a pressure (e.g., which may further correlate to a fit of the wearable ring device on the finger of the user), where collection of physiological data by the wearable ring device, changes in physiological data, or both, may be based on the pressure (e.g., hydration may be based on changes in pressure throughout the day, gaps in heart rate data may be explained by poor fit). As such, in some cases, the wearable ring device (e.g., a system associated with the wearable ring device) may adjust one or more parameters associated with the collection of the physiological data based on the pressure, a user device associated with the wearable ring device may display one or more insights associated with the changes in physiological data being explained by the pressure, or both.

Additionally, at least a second subset of one or more coils may function as one or more driver coils (e.g., in a second mode), where the circuity (e.g., one or more circuits) electronically coupled to the one or more driver coils may cause the one or more coils to exert a magnetic force on the one or more magnets (e.g., based on generation of a signal by the circuitry) that further causes the one or more magnets to move away from the one or more coils in a second direction, opposite the first direction (e.g., radially inward towards the finger of the user). Movement of the one or more magnets away from the one or more coils may cause the elastomer pad to deflect, or deform, in the second direction towards the finger of the user, thus exerting a second (e.g., compressive) force on the finger of the user, which may be detected by the user as haptic feedback.

In some cases, the elastomer pad may exert the second force on the finger of the user according to a feedback pattern. In other words, the circuitry may cause the one or more coils to exert the magnetic force in a series of pulses, or at different intensities, thus causing the elastomer pad to exert the second force on the finger of the user in accordance with the series of pulses, or in accordance with the different intensities, where a feedback pattern may be based on a quantity of pulses, an intensity of each pulse, a duration of each pulse, or any combination thereof. For example, a first feedback pattern may be associated with two pulses of the elastomer pad and a second feedback pattern may be associated with four pulses of the elastomer pad. Additionally, each feedback pattern may be associated with a different type of feedback. For example, the first feedback pattern may indicate first feedback associated with success of a contactless payment performed via the wearable ring device and the second feedback pattern may indicate second feedback associated with a battery level of the wearable ring device falling below a threshold. Other examples of feedback that may be indicated to a user via generation of haptic feedback in accordance with a corresponding feedback pattern may include feedback associated with physiological data of the user. For example, a third feedback pattern may indicate third feedback associated with a blood pressure of the user satisfying one or more thresholds (e.g., a first threshold blood pressure associated with high blood pressure or a second threshold blood pressure associated with low blood pressure) and a fourth feedback pattern may indicate feedback associated with a heart rate pattern of the user (e.g., the user is experiencing an irregular heart rate).

In some examples, the one or more detector coils and the one or more driver coils may be the same coils. In other words, the one or more coils may be capable of functioning as the one or more detector coils in the first mode and may be capable of functioning as the one or more driver coils in the second mode. In some other examples, the one or more detector coils and the one or more driver coils may be different coils. In other words, the first subset of the one or more coils may be different than the second subset of the one or more coils.

Aspects of the disclosure are initially described in the context of wearable ring devices. Additional aspects of the disclosure are described in the context of systems supporting physiological data collection from users via wearable devices. Aspects of the disclosure are further illustrated by and described with reference to apparatus diagrams, system diagrams, and flowcharts that relate to techniques for pressure-based haptic feedback.

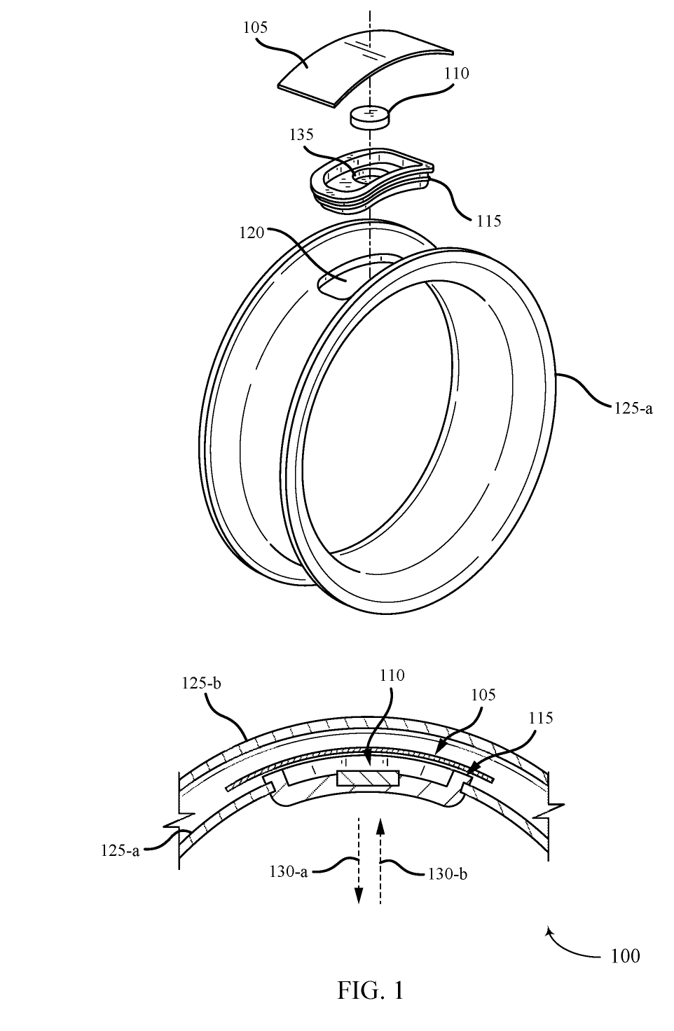

FIG. 1 shows an example of a wearable ring device 100 that supports techniques for pressure-based haptic feedback in accordance with aspects of the present disclosure.

In some cases, the wearable ring device 100 may include a sensor assembly capable of functioning as a pressure sensor and also capable of generating haptic feedback, where the sensor assembly includes a coil 105 (e.g., one or more coils 105), a magnet 110 (e.g., one or more magnets 110), and an elastomer pad 115 (e.g., a pad made of an elastic, or flexible, material capable of deformation, a flexible pad, a soft pad). More specifically, the wearable ring device 100 may include an inner housing 125-a (e.g., an inner housing 405-a) and an outer housing 125-b (e.g., an outer housing 405-b), and the inner housing 125-a may include an aperture 120 (e.g., cutout) in which the elastomer pad 115 is positioned. In other words, the elastomer pad 115 may be positioned at least partially within the aperture 120 such that a first portion of the elastomer pad 115 extends, or protrudes, past a first surface (e.g., outward facing surface) of the wearable ring device 100 (e.g., in a direction 130-a), a second portion of the elastomer pad extends past a second surface (e.g., internally facing surface) of the wearable ring device 100 (e.g., in a direction 130-b), or both. Thus, when a user is wearing the wearable ring device 100 on a finger, the elastomer pad 115 may contact the finger of the user and, in some cases, may be compressed (e.g., deformed in the direction 130-b) by the finger. That is, the finger of the user may exert a first (e.g., compressive) force onto the elastomer pad 115 in the direction 130-b (e.g., a first direction, away from the finger of the user, radially outward) that may cause the elastomer pad 115 to deflect, or deform, in the direction 130-b.

As discussed above, the wearable ring device 100 may additionally include a magnet 110 embedded in, or otherwise attached to, the elastomer pad 115. For example, the elastomer pad 115 may include a cavity 135 (e.g., a cutout) in which the magnet 110 may be positioned at least partially within. The magnet 110 may be positioned in the elastomer pad 115 such that the magnet 110 is between at least the first portion of the elastomer pad 115 and the coil 105 (e.g., positioned between the elastomer pad 115 and the outer housing 125-b), such that an “air gap” exists between the coil 105 and the magnet 110. In other words, the coil 105 may not contact the magnet 110 (e.g., at least when the wearable ring device 100 is not being worn by the user, at least when the elastomer pad 115 is not deformed in the direction 130-b).

In some cases, such as in a first mode, the coil 105 (e.g., a set of coils 105) may function as a detector coil 105. In such cases, circuitry electronically coupled with (e.g., attached to, controlling) the coil 105 may detect a change in voltage in the coil 105 based on deflection, or deformation, of the elastomer pad 115 in the direction 130-b. In other words, in a default state (e.g., when the wearable ring device 100 is not being worn by the user, neutral state), the magnet 110 may be located at a first distance from the coil 105, which may be referred to as a default (e.g., baseline) position, such that a current (e.g., a low amplitude oscillating current) across the coil 105 may be associated with a first voltage, which may be referred to as a baseline voltage. Thus, as discussed above, when the user is wearing the wearable ring device 100 on their finger, the finger of the user may exert a compressive force onto the elastomer pad 115 that causes the elastomer pad 115 (e.g., at least a portion of the elastomer pad 115) to deflect in the direction 130-b. Thus, the deflection in the direction 130-b may cause the magnet 110 to move closer to the coil 105 (e.g., as compared to the default position), where movement of the magnet 110 towards the coil 105 (e.g., the magnet 110 being closer to the coil 105) may cause the change in voltage of the current across the coil 105, which may be detected by the circuitry (e.g., by a system associated with the wearable ring device 100). In other words, the compressive force may cause the magnet 110 to move from the default position to a second position at a second distance from the coil 105, where the second distance is shorter than the first distance (e.g., the second position is closer to the coil 105). Thus, the magnet 110 being positioned at the second distance from the coil 105 may cause the current in the coil 105 to be associated with a second voltage, different from the baseline voltage, such that the circuitry (e.g., the system associated with the wearable ring device) may detect the change in voltage, or the difference in voltage, from the baseline voltage to the second voltage.

In other words, during the first mode, the coil 105 may be energized (e.g., by the circuitry) at a low amplitude oscillating current that generates reciprocating and alternating magnetic fields in the magnet 110, which may be received by the coil 105. Thus, the compressive force (e.g., pressure) on the elastomer pad 115 by the finger of the user may result in a shift in an amplitude, a phase, or both, of a signal, or current, in the coil 105, where the shift in amplitude, phase, or both, may correlate to the pressure.

In such cases, the change in voltage may correlate to a pressure, which may further correlate to a fit of the wearable ring device 100 on the finger of the user. In other words, the system may determine the pressure exerted onto the elastomer pad 115 (e.g., by the finger) based on the change in voltage and may further determine the fit of the wearable ring device 100 based on the pressure. For example, a first pressure satisfying a threshold pressure may indicate a good fit of the wearable ring device 100 and a second pressure failing to satisfy the threshold pressure may indicate a poor fit (e.g., too loose of a fit) of the wearable ring device 100. In some cases, the system may adjust measurement of physiological data based on the fit of the wearable ring device 100, such that when the wearable ring device 100 is associated with a good fit (e.g., the first pressure satisfying the threshold pressure), the system may refrain from adjusting the measurement of the physiological data and, conversely, when the wearable ring device 100 is associated with a poor fit (e.g., the first pressure failing to satisfy the threshold pressure), the system may adjust the measurement of the physiological data. In other words, the system may adjust one or more parameters associated with measurement of physiological data via the wearable ring device 100 based on the pressure (e.g., the detected change in voltage). Additionally, or alternatively, the system may use the pressure (e.g., fit) to explain, determine, or otherwise provide insights related to physiological data, changes in physiological data, or both. For example, gaps (e.g., missed data) in heart rate data may be due to a poor fit of the wearable ring device 100. In another example, hydration of the user (e.g., hydration data) may be based on changes in pressure throughout a duration (e.g., a day). That is, a first pressure may be associated with the user being hydrated and a second pressure may be associated with the user being dehydrated.

Additionally, or alternatively, the user may indicate information (e.g., instructions, commands, user inputs, user feedback) to the system associated with the wearable ring device via application of a force (e.g., pressure) to the outer housing 125-b, resulting in the compressive force (e.g., pressure) on the elastomer pad 115 by the finger of the user. That is, when the user applies the force to the outer housing 125-b, the force may push the wearable ring device 100 in a direction of the finger of the user, causing the elastomer pad 115 to deform due to a compressive force generated between the elastomer pad 115 and the finger of the user due to the force applied to the outer housing 125-b. In other words, rather than (e.g., or in combination with) the compressive force between the elastomer pad 115 and the finger of the user being based on a size of the finger relative to a size of the wearable ring device 100 (e.g., a fit of the wearable ring device), the compressive force may be based on an intentional force applied by the user to the outer housing 125-b. In such cases, a pattern associated with the force (e.g., one or more forces) applied by the user to the outer housing 125-b may correlate (e.g., correspond) to information to be indicated to the system, such as a command (e.g., start an activity, open a lock), a user input (e.g., a tag), user feedback (e.g., a response to a prompt by the system), or the like thereof. For example, applying the force once, waiting one second, and then applying the force again may cause the system to open a car door when the user is in a proximity to the car. Different patterns associated with the force (e.g., one or more forces) applied by the user to the outer housing 125-b may correspond to different information to be indicated to the system.

Additionally, in a second mode, the coil 105 may function as a driver coil 105. In such cases, circuitry electronically coupled with (e.g., attached to, controlling) the coil 105 may generate a current (e.g., an oscillating current) in the coil 105 that induces a magnetic force between the coil 105 and the magnet 110, causing the elastomer pad 115 to deflector deform, in the direction 130-a (e.g., a second direction, towards the finger of the user, radially inward). In other words, as discussed above, in the default state, the magnet 110 may be located at the first distance from the coil 105, in the default position. Thus, when the circuitry generates a current across the coil 105 that exceeds a threshold current, a magnetic force may be induced between the coil 105 and the magnet 110, causing the magnet 110 to move further away from the coil 105 in the direction 130-a to a third position at a third distance from the coil 105, where the third distance is longer than the first distance. In other words, the coil 105 may be located at a fixed position and the magnet 110 may be located at a moveable position (e.g., due to flexibility, or elasticity, or the elastomer pad 115) such that the magnetic force causes the magnet 110 to move. Movement of the magnet 110 may further cause the elastomer pad 115 to deflect, or deform, in the direction 130-a, thus exerting a force on the finger of the user, which may correlate to (e.g., be perceived by the user as) haptic feedback. In other words, the circuitry may generate the current exceeding the threshold current as a pulse (e.g., a pulse of current) such that, at a first time, the elastomer pad 115 moves to the third position, applying the force to the finger of the user and, at a second time after the first time, returns to the default position, where a difference between the first time and the second time is equal to a pulse duration.

In some cases, the elastomer pad 115 may exert the force on the finger of the user (e.g., based on generation of the current exceeding the threshold) according to a feedback pattern. In other words, the circuitry may cause the coil 105 to exert the magnetic force via one or more pulses (e.g., by pulsing the current), where a quantity of the one or more pulses, a duration of each of the one or more pulses, an intensity of each of the one or more pulses, or any combination thereof, is based on an associated feedback pattern. That is, each feedback pattern may be associated with a respective value of each parameter of a set of parameters associated with generation of the current, such as voltage, frequency, and waveform. For example, a first feedback pattern may be associated with two pulses of the elastomer pad 115 at a same intensity and a second feedback pattern may be associated with four pulses of the elastomer pad 115 at alternating intensities. Additionally, each feedback pattern may correspond to a different type of feedback. For example, the first feedback pattern may be associated with first feedback indicating that the user has met an activity goal for the day and the second feedback pattern may be associated with second feedback indicating that the user has been stationary for a duration exceeding a threshold duration and should get up and move. Feedback may include any type of information that may be communicated from any component or combination of components of the system associated with the wearable ring device 100 to the user.

In some cases, the wearable ring device 100 may include multiple sensor assemblies (e.g., not depicted). For example, the wearable ring device 100 may include a first sensor assembly, positioned relative to a first aperture 120, including a first coil 105, a first magnet 110, and a first elastomer pad 115, and a second sensor assembly, positioned relative to a second aperture 120, including a second coil 105, a second magnet 110, and a second elastomer pad 115. In such cases, one or more feedback patterns may further be defined by varying pulses across the multiple sensor assemblies. For example, a third feedback pattern may be associated with (e.g., correspond to) two pulses of the first elastomer pad 115 followed by one pulse of the second elastomer pad.

In some cases, a thickness, durometer, or both, of the elastomer pad 115 may enable the wearable ring device 100 to fit (e.g., move) over a knuckle of the finger of the user while still enabling a good fit of the wearable ring device 100 on the finger of the user (e.g., a non-knuckle portion of the finger) for a variety of intermediate ring sizes. In other words, a wearable ring device 100 corresponding to a size 5 may actually fit fingers within a range of sizes from size 4.5 to size 5.5. In some examples, the first portion of the elastomer pad 115 may extend far enough past the first surface of the inner housing 125-a, such that the wearable ring device 100 may accommodate a half to a full ring size beyond a size of the wearable ring device 100. Additionally, or alternatively, the elastomer pad 115 (e.g., and the aperture 120) may span a section of the inner housing 125-a that may be based on the size of the wearable ring device 100.

In some examples, a material of the elastomer pad 115 may be associated with a threshold frictional force between the elastomer pad 115 and the finger of the user. In other words, the material of the elastomer pad 115 may be associated with one or more material properties such that a frictional force between the elastomer pad 115 and the finger of the user exceeds the threshold frictional force, thus preventing or reducing rotation of the wearable ring device 100 around the finger of the user. Additionally, or alternatively, in some cases, the elastomer pad 115 may be molded (e.g., over-molded) onto the inner housing 125-a, where the elastomer pad 115 is made of a thermoplastic material (e.g., material capable of deforming under application of heat). Additionally, or alternatively, the elastomer pad 115 may be molded as a separate piece and may be attached (e.g., bonded) to the inner housing 125-a via adhesive (e.g., around one or more edges of the elastomer pad 115).

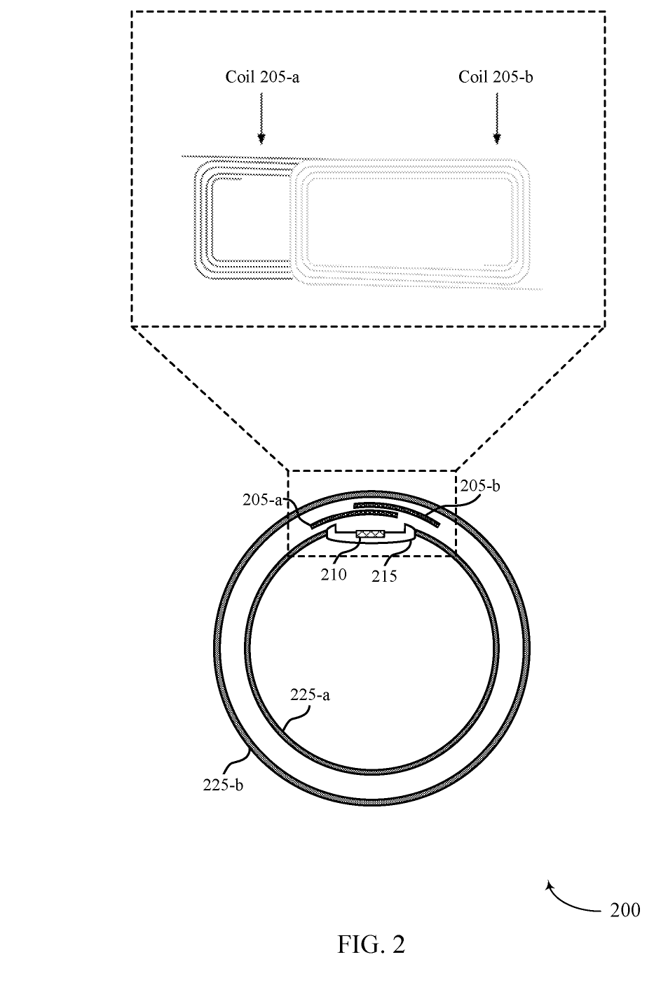

Though described and depicted in the context of the magnet 110 and the coil 105, this is not to be regarded as a limitation of the present disclosure. In this regard, each sensor assembly may include any quantity of magnets and any quantity of coils 105, as described further with reference to FIG. 2. Additionally, or alternatively, though described in the context of the coil 105, this is not to be regarded as a limitation of the present disclosure. In this regard, the coil 105 may refer to a set of one or more coils printed on a flexible printed circuit board, such that the coil 105.

FIG. 2 shows an example of a wearable ring device 200 that supports techniques for pressure-based haptic feedback in accordance with aspects of the present disclosure.

As described with reference to FIG. 1, in some cases, a wearable ring device 200 (e.g., including an inner housing 225-a and an outer housing 225-b) may include a sensor assembly that is capable of functioning as a pressure sensor and is also capable of generating haptic feedback, where the sensor assembly includes one or more coils 205 (e.g., one or more coils 105) capable of functioning as one or more driver coils 205 (e.g., in a first mode) and one or more detector coils 205 (e.g., in a second mode). As depicted in FIG. 1, in some cases, the one or more coils 205 may include a single coil 105 (e.g., a single set of coils 105) that is capable of functioning as both the one or more driver coils 205 and the one or more detector coils 205. In other words, circuitry (e.g., coupled with the single coil 205) may be capable of inducing a magnetic force via a same coil 205 that the circuitry is capable of detecting a change in voltage. For example, at a first time (e.g., during a first duration), the single coil 205 may operate in (e.g., according to) the first mode in which the circuity generates a current via the single coil 205 that induces a magnetic force between the single coil 205 and a magnet 210 (e.g., a magnet 110) of the sensor assembly, causing the elastomer pad 215 of the sensor assembly (e.g., an elastomer pad 115) to deflect in a first direction (e.g., towards a finger of a user, a direction 130-a), thus generating haptic feedback. At a second time (e.g., during a second duration), the single coil 205 may operate in the second mode in which the circuity may detect a change in voltage across the single coil 205 (e.g., a change in voltage in a current in the single coil 205) due to deflection of the elastomer pad 215 in a second direction (e.g., away from the finger of the user, a direction 130-b) that may correlate to a pressure applied by the finger of the user onto the elastomer pad 215.

In some other cases, as depicted in FIG. 2, the one or more coils 205 may include multiple coils 205 (e.g., multiple sets of coils 205), such as a coil 205-a and a coil 205-b, where the coil 205-a (e.g., a first set of coils 205) may be a driver coil 205-a and the coil 205-b (e.g., a second set of coils 205) may be a detector coil 205-b. Thus, in the first mode, first circuitry coupled with the coil 205-a may generate (e.g., be capable of generating) the current via the coil 205-a that induces the magnetic force between the coil 205-a and magnet 210 of the sensor assembly, causing the elastomer pad 215 of the sensor assembly to deflect in the first direction (e.g., towards the finger of the user), thus generating haptic feedback. Conversely, in the second mode, second circuitry coupled with the coil 205-b (e.g., the same or different as the first circuitry) may detect the change in voltage across the coil 205-b due to deflection of the elastomer pad 215 in the second direction (e.g., away from the finger of the user) that may correlate to the pressure applied by the finger of the user onto the elastomer pad 215 (e.g., while the wearable ring device 200 is worn). Though the coil 205-a may be different than the coil 205-b, the wearable ring device 200 (e.g., a system associated with the wearable ring device 200) may refrain from using the coil 205-a and the coil 205-b at the same time. That is, the first circuitry may refrain from generating the current via the coil 205-a when the second circuitry is detecting the change in voltage across the coil 205-b (e.g., and visa-versa). For example, the second circuitry may detect the change in voltage across the coil 205-b at a third time (e.g., during a third duration, after the user first puts the wearable ring device 200 on their finger) and, after the second circuitry completes (e.g., finishes) detection of the voltage (e.g., at a fourth time, during a fourth duration), the first circuitry may generate the current via the coil 205-a to generate haptic feedback.

In some cases, the coil 205-a may be offset from the coil 205-b at a position that results in a net-zero magnetic flux in a default position (e.g., when the wearable ring device 200 is not being worn). In other words, when no pressure is applied on the elastomer pad 215, the coil 205-b may read zero signal. Thus, any pressure on the elastomer pad 215 would disturb a magnetic field of the coil 205-b, thus causing a signal to be read by the coil 205-b. Additionally, or alternatively, the magnet 210 may include a conductive component, such as a stamped steel component (e.g., part) around the permanent magnet.

In some examples, instead of the coil 205-a, the wearable ring device 200 may include a Hall effect sensor that detects a proximity of the magnet 210 to the Hall effect sensor, where the proximity may correlate to the pressure. Additionally, or alternatively, the system associated with the wearable ring may detect pressure based on changes in system dynamics. That is, pressure on the elastomer pad 215 may disrupt a natural resonant frequency of the sensor assembly during haptic feedback. Thus, the system may determine the pressure by generating a vibration (e.g., less than a threshold, small vibration) at different frequencies, or by generating a minute pulse and observing a settling time of the system. Additionally, or alternatively, the system may detect changes in an amount of pressure, movement of the elastomer pad 215 (e.g., and the magnet 210), or both, based on detection of a current induced in the coil 205-a based on movement of the magnet 210.

Though depicted in the context of the coil 205-a and the coil 205-b, this is not to be regarded as a limitation of the present disclosure. In this regard, each of the coil 205-a and the coil 205-b may have any quantity of coils 205, such that the coil 205-a is a first set of coils 205 and the coil 205-b is a second set of coils 205. Additionally, or alternatively, the wearable ring device 200 may include any quantity of coils 205 (e.g., or sets of coils 205). For example, the wearable ring device 200 may include a coil 205-c (e.g., not depicted) that is capable of functioning as a driver coil 205, is capable of functioning as a detector coil 205, is capable of functioning as both the driver coil 205 and the detector coil 205, is capable of performing one or more other functions, or any combination thereof.

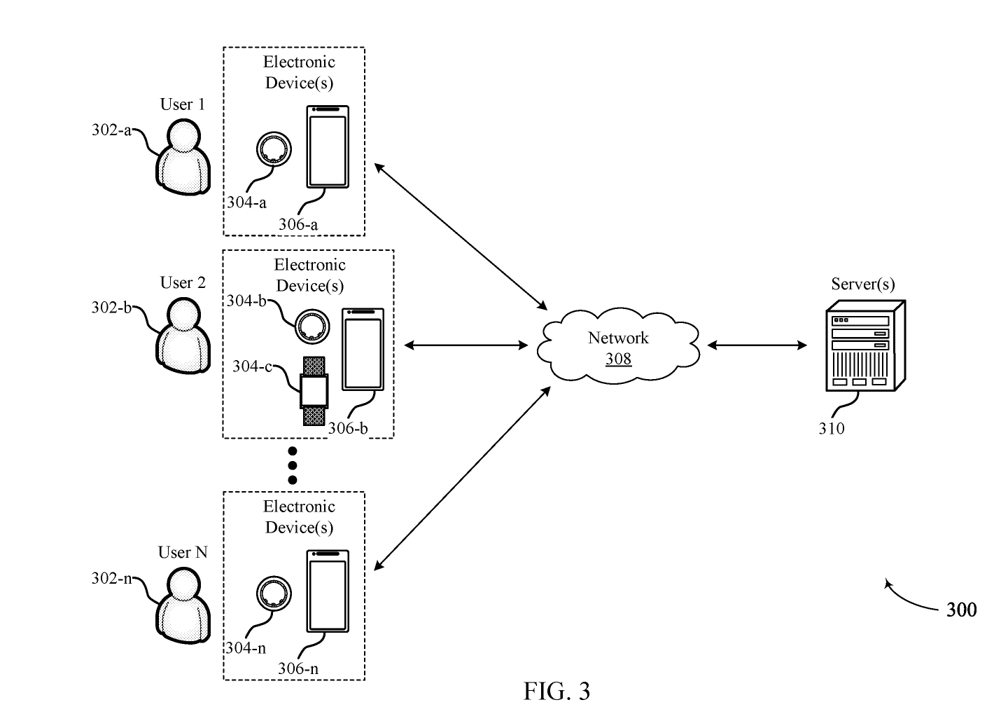

FIG. 3 illustrates an example of a system 300 that supports techniques for pressure-based haptic feedback in accordance with aspects of the present disclosure. The system 300 includes a plurality of electronic devices (e.g., wearable devices 304, user devices 306) that may be worn and/or operated by one or more users 302. The system 300 further includes a network 308 and one or more servers 310.

The electronic devices may include any electronic devices known in the art, including wearable devices 304 (e.g., ring wearable devices, watch wearable devices, etc.), user devices 306 (e.g., smartphones, laptops, tablets). The electronic devices associated with the respective users 302 may include one or more of the following functionalities: 1) measuring physiological data, 2) storing the measured data, 3) processing the data, 4) providing outputs (e.g., via GUIs) to a user 302 based on the processed data, and 5) communicating data with one another and/or other computing devices. Different electronic devices may perform one or more of the functionalities.

Example wearable devices 304 may include wearable computing devices, such as a ring computing device (hereinafter “ring”) configured to be worn on a user’s 302 finger, a wrist computing device (e.g., a smart watch, fitness band, or bracelet) configured to be worn on a user’s 302 wrist, and/or a head mounted computing device (e.g., glasses/goggles). Wearable devices 304 may also include bands, straps (e.g., flexible or inflexible bands or straps), stick-on sensors, and the like, that may be positioned in other locations, such as bands around the head (e.g., a forehead headband), arm (e.g., a forearm band and/or bicep band), and/or leg (e.g., a thigh or calf band), behind the ear, under the armpit, and the like. Wearable devices 304 may also be attached to, or included in, articles of clothing. For example, wearable devices 304 may be included in pockets and/or pouches on clothing. As another example, wearable device 304 may be clipped and/or pinned to clothing, or may otherwise be maintained within the vicinity of the user 302. Example articles of clothing may include, but are not limited to, hats, shirts, gloves, pants, socks, outerwear (e.g., jackets), and undergarments. In some implementations, wearable devices 304 may be included with other types of devices such as training/sporting devices that are used during physical activity. For example, wearable devices 304 may be attached to, or included in, a bicycle, skis, a tennis racket, a golf club, and/or training weights.

Much of the present disclosure may be described in the context of a wearable device 304, which may include finger-worn wearable devices, wrist-worn wearable devices, and the like. Accordingly, the terms “wearable device 304,” “wearable ring device,” “ring,” and like terms, may be used interchangeably, unless noted otherwise herein. However, the use of the terms “wearable ring device” and/or “ring” are not to be regarded as limiting, as it is contemplated herein that aspects of the present disclosure may be performed using other wearable devices (e.g., watch wearable devices, necklace wearable device, bracelet wearable devices, earring wearable devices, anklet wearable devices, and the like).

In some aspects, user devices 306 may include handheld mobile computing devices, such as smartphones and tablet computing devices. User devices 306 may also include personal computers, such as laptop and desktop computing devices. Other example user devices 306 may include server computing devices that may communicate with other electronic devices (e.g., via the Internet). In some implementations, computing devices may include medical devices, such as external wearable computing devices (e.g., Holter monitors). Medical devices may also include implantable medical devices, such as pacemakers and cardioverter defibrillators. Other example user devices 306 may include home computing devices, such as internet of things (IoT) devices (e.g., IoT devices), smart televisions, smart speakers, smart displays (e.g., video call displays), hubs (e.g., wireless communication hubs), security systems, smart appliances (e.g., thermostats and refrigerators), and fitness equipment.

Some electronic devices (e.g., wearable devices 304, user devices 306) may measure physiological parameters of respective users 302, such as photoplethysmography waveforms, continuous skin temperature, a pulse waveform, respiration rate, heart rate, heart rate variability (HRV), actigraphy, galvanic skin response, pulse oximetry, blood oxygen saturation (SpO2), blood sugar levels (e.g., glucose metrics), and/or other physiological parameters. Some electronic devices that measure physiological parameters may also perform some/all of the calculations described herein. Some electronic devices may not measure physiological parameters, but may perform some/all of the calculations described herein. For example, a ring (e.g., wearable device 304), mobile device application, or a server computing device may process received physiological data that was measured by other devices.

In some implementations, a user 302 may operate, or may be associated with, multiple electronic devices, some of which may measure physiological parameters and some of which may process the measured physiological parameters. In some implementations, a user 302 may have a ring (e.g., wearable device 304) that measures physiological parameters. The user 302 may also have, or be associated with, a user device 306 (e.g., mobile device, smartphone), where the wearable device 304 and the user device 306 are communicatively coupled to one another. In some cases, the user device 306 may receive data from the wearable device 304 and perform some/all of the calculations described herein. In some implementations, the user device 306 may also measure physiological parameters described herein, such as motion/activity parameters.

For example, as illustrated in FIG. 3, a first user 302-a (User 1) may operate, or may be associated with, a wearable device 304-a (e.g., wearable ring device) and a user device 306-a that may operate as described herein. In this example, the user device 306-a associated with user 302-a may process/store physiological parameters measured by the wearable device 304-a. Comparatively, a second user 302-b (User 2) may be associated with wearable devices 304-b and 304-c (e.g., wearable ring device and a wrist-worn wearable device, such as a watch) and a user device 306-b, where the user device 306-b associated with user 302-b may process/store physiological parameters measured by the wearable devices 304-b and 304-c. Moreover, an nth user 302-n (User N) may be associated with an arrangement of electronic devices described herein (e.g., wearable device 304-n, user device 306-n). In some aspects, wearable devices 304 (e.g., wearable ring devices, wrist-worn wearable devices) and other electronic devices may be communicatively coupled to the user devices 306 of the respective users 302 via Bluetooth, Wi-Fi, and other wireless protocols. Moreover, in some cases, the wearable device 304 and the user device 306 may be included within (or make up) the same device. For example, in some cases, the wearable device 304 may be configured to execute an application associated with the wearable device 304, and may be configured to display data via a GUI.

In some implementations, the wearable devices 304 (e.g., wearable ring devices) of the system 300 may be configured to collect physiological data from the respective users 302 based on arterial blood flow within the user’s finger. In particular, a wearable ring device may utilize one or more light-emitting components, such as LEDs (e.g., red LEDs, green LEDs) that emit light on the palm-side of a user’s finger to collect physiological data based on arterial blood flow within the user’s finger. In general, the terms light-emitting components, light-emitting elements, and like terms, may include, but are not limited to, LEDs, micro LEDs, mini LEDs, laser diodes (LDs) (e.g., vertical cavity surface-emitting lasers (VCSELs), and the like.

In some cases, the system 300 may be configured to collect physiological data from the respective users 302 based on blood flow diffused into a microvascular bed of skin with capillaries and arterioles. For example, the system 300 may collect PPG data based on a measured amount of blood diffused into the microvascular system of capillaries and arterioles. In some implementations, the wearable device 304 may acquire the physiological data using a combination of both green and red LEDs. The physiological data may include any physiological data known in the art including, but not limited to, temperature data, accelerometer data (e.g., movement/motion data), heart rate data, HRV data, blood oxygen level data, or any combination thereof.

The use of both green and red LEDs may provide several advantages over other solutions, as red and green LEDs have been found to have their own distinct advantages when acquiring physiological data under different conditions (e.g., light/dark, active/inactive) and via different parts of the body, and the like. For example, green LEDs have been found to exhibit better performance during exercise. Moreover, using multiple LEDs (e.g., green and red LEDs) distributed around the wearable device 304 (e.g., around an inner surface of the wearable ring device) has been found to exhibit superior performance as compared to wearable devices that utilize LEDs that are positioned close to one another, such as within a watch wearable device. Furthermore, the blood vessels in the finger (e.g., arteries, capillaries) are more accessible via LEDs as compared to blood vessels in the wrist. In particular, arteries in the wrist are positioned on the bottom of the wrist (e.g., palm-side of the wrist), meaning only capillaries are accessible on the top of the wrist (e.g., back of hand side of the wrist), where wearable watch devices and similar devices are typically worn. As such, utilizing LEDs and other sensors within a wearable ring device has been found to exhibit superior performance as compared to wearable devices worn on the wrist, as the wearable ring device may have greater access to arteries (as compared to capillaries), thereby resulting in stronger signals and more valuable physiological data.

The electronic devices of the system 300 (e.g., user devices 306, wearable devices 304) may be communicatively coupled to one or more servers 310 via wired or wireless communication protocols. For example, as shown in FIG. 3, the electronic devices (e.g., user devices 306) may be communicatively coupled to one or more servers 310 via a network 308. The network 308 may implement transfer control protocol and internet protocol (TCP/IP), such as the Internet, or may implement other network 308 protocols. Network connections between the network 308 and the respective electronic devices may facilitate transport of data via email, web, text messages, mail, or any other appropriate form of interaction within a computer network 308. For example, in some implementations, the wearable device 304-a associated with the first user 302-a may be communicatively coupled to the user device 306-a, where the user device 306-a is communicatively coupled to the servers 310 via the network 308. In additional or alternative cases, wearable devices 304 (e.g., wearable ring devices, wrist-worn wearable devices such as watches) may be directly communicatively coupled to the network 308.

The system 300 may offer an on-demand database service between the user devices 306 and the one or more servers 310. In some cases, the servers 310 may receive data from the user devices 306 via the network 308, and may store and analyze the data. Similarly, the servers 310 may provide data to the user devices 306 via the network 308. In some cases, the servers 310 may be located at one or more data centers. The servers 310 may be used for data storage, management, and processing. In some implementations, the servers 310 may provide a web-based interface to the user device 406 via web browsers.

In some aspects, the system 300 may detect periods of time that a user 302 is asleep, and classify periods of time that the user 302 is asleep into one or more sleep stages (e.g., sleep stage classification). For example, as shown in FIG. 3, User 302-a may be associated with a wearable device 304-a (e.g., wearable ring device) and a user device 306-a. In this example, the wearable device 304-a may collect physiological data associated with the user 302-a, including temperature, heart rate, HRV, respiratory rate, and the like. In some aspects, data collected by the wearable device 304-a may be input to a machine learning classifier, where the machine learning classifier is configured to determine periods of time that the user 302-a is (or was) asleep. Moreover, the machine learning classifier may be configured to classify periods of time into different sleep stages, including an awake sleep stage, a rapid eye movement (REM) sleep stage, a light sleep stage (non-REM (NREM)), and a deep sleep stage (NREM). In some aspects, the classified sleep stages may be displayed to the user 302-a via a GUI of the user device 306-a. Sleep stage classification may be used to provide feedback to a user 302-a regarding the user’s sleeping patterns, such as recommended bedtimes, recommended wake-up times, and the like. Moreover, in some implementations, sleep stage classification techniques described herein may be used to calculate scores for the respective user, such as Sleep Scores, Readiness Scores, and the like.

In some aspects, the system 300 may utilize circadian rhythm-derived features to further improve physiological data collection, data processing procedures, and other techniques described herein. The term circadian rhythm may refer to a natural, internal process that regulates an individual’s sleep-wake cycle, that repeats approximately every 24 hours. In this regard, techniques described herein may utilize circadian rhythm adjustment models to improve physiological data collection, analysis, and data processing. For example, a circadian rhythm adjustment model may be input into a machine learning classifier along with physiological data collected from the user 302-a via the wearable device 304-a. In this example, the circadian rhythm adjustment model may be configured to “weight,” or adjust, physiological data collected throughout a user’s natural, approximately 24-hour circadian rhythm. In some implementations, the system may initially start with a “baseline” circadian rhythm adjustment model, and may modify the baseline model using physiological data collected from each user 302 to generate tailored, individualized circadian rhythm adjustment models that are specific to each respective user 302.

In some aspects, the system 300 may utilize other biological rhythms to further improve physiological data collection, analysis, and processing by phase of these other rhythms. For example, if a weekly rhythm is detected within an individual’s baseline data, then the model may be configured to adjust “weights” of data by day of the week. Biological rhythms that may require adjustment to the model by this method include: 1) ultradian (faster than a day rhythms, including sleep cycles in a sleep state, and oscillations from less than an hour to several hours periodicity in the measured physiological variables during wake state; 2) circadian rhythms; 3) non-endogenous daily rhythms shown to be imposed on top of circadian rhythms, as in work schedules; 4) weekly rhythms, or other artificial time periodicities exogenously imposed (e.g., in a hypothetical culture with 12 day “weeks,” 12 day rhythms could be used); 5) multi-day ovarian rhythms in women and spermatogenesis rhythms in men; 6) lunar rhythms (relevant for individuals living with low or no artificial lights); and 7) seasonal rhythms.

The biological rhythms are not always stationary rhythms. For example, many women experience variability in ovarian cycle length across cycles, and ultradian rhythms are not expected to occur at exactly the same time or periodicity across days even within a user. As such, signal processing techniques sufficient to quantify the frequency composition while preserving temporal resolution of these rhythms in physiological data may be used to improve detection of these rhythms, to assign phase of each rhythm to each moment in time measured, and to thereby modify adjustment models and comparisons of time intervals. The biological rhythm-adjustment models and parameters can be added in linear or non-linear combinations as appropriate to more accurately capture the dynamic physiological baselines of an individual or group of individuals.

In some aspects, the wearable ring devices 304 of the system 300 may support sensor assemblies capable of functioning as pressure sensors and capable of generating haptic feedback, where each sensor assembly includes one or more coils (e.g., a coil 105), one or more magnets (e.g., a magnet 110), and an elastomer pad (e.g., an elastomer pad 115). More specifically, a wearable ring device 304 may include an inner housing (e.g., an inner housing 405-a) and an outer housing (e.g., an outer housing 405-b), and the inner housing 125-a may include an aperture (e.g., an aperture 120) in which the elastomer pad may be positioned. The wearable ring device 304 may additionally include one or more magnets embedded in, or otherwise attached to, the elastomer pad, where the one or more magnets are positioned in the elastomer pad such that the one or more magnets are between at least the first portion of the elastomer pad and the one or more coils.

It should be appreciated by a person skilled in the art that one or more aspects of the disclosure may be implemented in a system 300 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

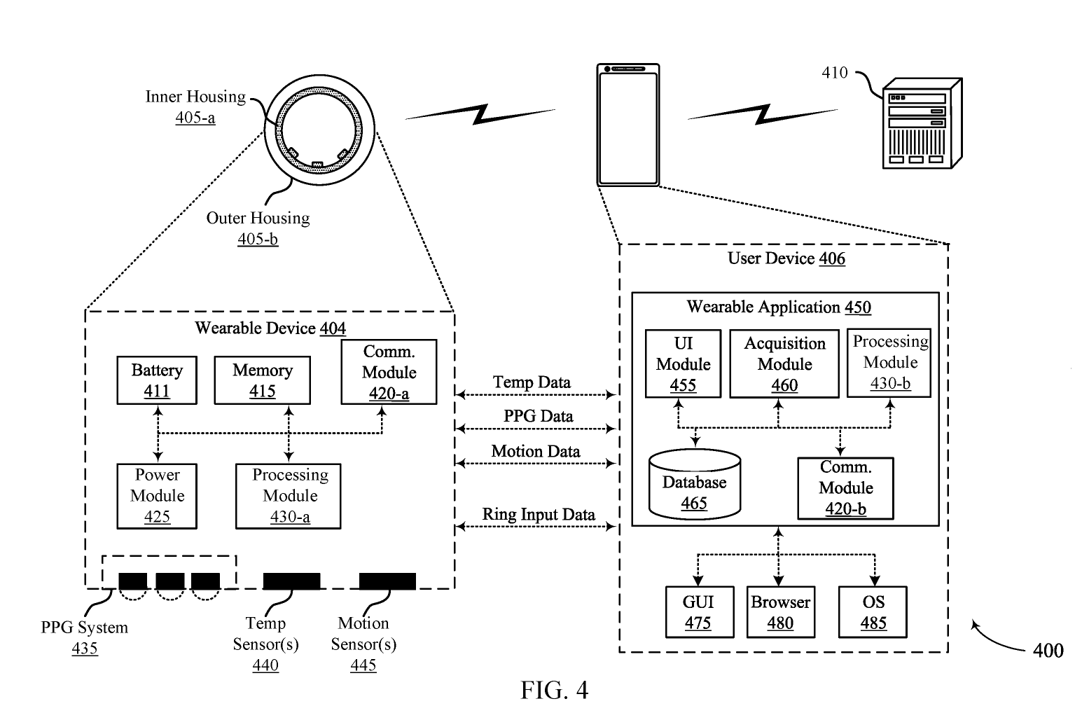

FIG. 4 illustrates an example of a system 400 that supports techniques for pressure-based haptic feedback in accordance with aspects of the present disclosure. The system 400 may implement, or be implemented by, system 300. In particular, system 400 illustrates a wearable device 404 (e.g., wearable ring device), a user device 406, and a server 410, as described with reference to FIG. 3.

In some aspects, the wearable device 404 (e.g., wearable ring device) may be configured to be worn around a user’s finger, and may determine one or more user physiological parameters when worn around the user’s finger. Example measurements and determinations may include, but are not limited to, user skin temperature, pulse waveforms, respiratory rate, heart rate, HRV, blood oxygen levels (SpO2), blood sugar levels (e.g., glucose metrics), and the like.

The system 400 further includes a user device 406 (e.g., a smartphone) in communication with the wearable device 404. For example, the wearable device 404 may be in wireless and/or wired communication with the user device 406. In some implementations, the wearable device 404 may send measured and processed data (e.g., temperature data, photoplethysmogram (PPG) data, motion/accelerometer data, ring input data, and the like) to the user device 406. The user device 406 may also send data to the wearable device 404, such as firmware/configuration updates. The user device 406 may process data. In some implementations, the user device 406 may transmit data to the server 410 for processing and/or storage.

The wearable device 404 may include a housing 405 that may include an inner housing 405-a and an outer housing 405-b. In some aspects, the inner housing 405-a, the outer housing 405-b, or both, may include a curved profile/surface. In particular, the housing 405 may exhibit any curved or “circumferential” profile, including a circular profile, an elliptical profile, and the like. Moreover, in some cases, the inner housing 405-a, the outer housing 405-b, or both, may include both curved (e.g., “circumferential”) and flat/planar portions. For the purposes of the present disclosure, the term “circumferential” may be used interchangeably with the term “curved” to refer to circular-shaped, elliptical-shaped, or other curved-shaped profile.

In some aspects, the housing 405 of the wearable device 404 may store or otherwise include various components of the ring including, but not limited to, device electronics, a power source (e.g., battery 411, and/or capacitor), one or more substrates (e.g., printable circuit boards) that interconnect the device electronics and/or power source, and the like. The device electronics may include device modules (e.g., hardware/software), such as: a processing module 430-a, a memory 415, a communication module 420-a, a power module 425, and the like. The device electronics may also include one or more sensors. Example sensors may include one or more temperature sensors 440, a PPG sensor assembly (e.g., PPG system 435), and one or more motion sensors 445.

The sensors may include associated modules (not illustrated) configured to communicate with the respective components/modules of the wearable device 404, and generate signals associated with the respective sensors. In some aspects, each of the components/modules of the wearable device 404 may be communicatively coupled to one another via wired or wireless connections. Moreover, the wearable device 404 may include additional and/or alternative sensors or other components that are configured to collect physiological data from the user, including light sensors (e.g., LEDs), oximeters, and the like.

The wearable device 404 shown and described with reference to FIG. 4 is provided solely for illustrative purposes. As such, the wearable device 404 may include additional or alternative components as those illustrated in FIG. 4. Additional or alternative wearable devices 404 that provide functionality described herein may be fabricated. For example, wearable devices 404 with fewer components (e.g., sensors) may be fabricated. In a specific example, a wearable device 404 with a single temperature sensor 440 (or other sensor), a power source, and device electronics configured to read the single temperature sensor 440 (or other sensor) may be fabricated. In another specific example, a temperature sensor 440 (or other sensor) may be attached to a user’s finger (e.g., using adhesives, wraps, clamps, spring loaded clamps, etc.). In this case, the sensor may be wired to another computing device, such as a wrist worn computing device that reads the temperature sensor 440 (or other sensor). In other examples, a wearable device 404 that includes additional sensors and processing functionality may be fabricated.

The housing 405 may include one or more housing components. The housing 405 may include an outer housing 405-b component (e.g., a shell) and an inner housing 405-a component (e.g., a molding). The housing 405 may include additional components (e.g., additional layers) not explicitly illustrated in FIG. 4. For example, in some implementations, the wearable device 404 may include one or more insulating layers that electrically insulate the device electronics and other conductive materials (e.g., electrical traces) from the outer housing 405-b. The housing 405 may provide structural support for the device electronics, battery 411, substrate(s), and other components. For example, the housing 405 may protect the device electronics, battery 411, and substrate(s) from mechanical forces, such as pressure and impacts. The housing 405 may also protect the device electronics, battery 411, and substrate(s) from water and/or other chemicals.

The inner housing 405-a may be configured to interface with the user’s finger. The inner housing 405-a may be formed from a polymer (e.g., a medical grade polymer) or other material. In some implementations, the inner housing 405-a may be transparent. For example, the inner housing 405-a may be transparent to light emitted by the PPG LEDs. In some implementations, the inner housing 405-a component may be molded onto the outer housing 405-b. For example, the inner housing 405-a may include a polymer that is molded (e.g., injection molded) to fit into an outer housing 405-b metallic shell.

The inner housing 405-a and the outer housing 405-b may be fabricated from one or more materials. In some implementations, the inner housing 405-a, the outer housing 405-b, or both, may include a metal, such as titanium, that may provide strength and abrasion resistance at a relatively light weight. Additionally, or alternatively, the inner housing 405-a, and/or the outer housing 405-b may also be fabricated from other materials, such polymers, plastic materials, epoxy materials, ceramic materials, and the like. In some implementations, the outer housing 405-b may be protective as well as decorative.

The wearable device 404 may include one or more substrates (not illustrated). The device electronics and battery 411 may be included on the one or more substrates. For example, the device electronics and battery 411 may be mounted on one or more substrates. Example substrates may include one or more printed circuit boards (PCBs), such as flexible PCB (e.g., polyimide). In some implementations, the electronics/battery 411 may include surface mounted devices (e.g., surface-mount technology (SMT) devices) on a flexible PCB. In some implementations, the one or more substrates (e.g., one or more flexible PCBs) may include electrical traces that provide electrical communication between device electronics. The electrical traces may also connect the battery 411 to the device electronics.

The device electronics, battery 411, and substrates may be arranged in the wearable device 404 in a variety of ways. In some implementations, one substrate that includes device electronics may be mounted along the bottom of the wearable device 404 (e.g., the bottom half), such that the sensors (e.g., PPG system 435, temperature sensors 440, motion sensors 445, and other sensors) interface with the underside of the user’s finger. In these implementations, the battery 411 may be included along the top portion of the wearable device 404 (e.g., on another substrate).

The various components/modules of the wearable device 404 represent functionality (e.g., circuits and other components) that may be included in the wearable device 404. Modules may include any discrete and/or integrated electronic circuit components that implement analog and/or digital circuits capable of producing the functions attributed to the modules herein. For example, the modules may include analog circuits (e.g., amplification circuits, filtering circuits, analog/digital conversion circuits, and/or other signal conditioning circuits). The modules may also include digital circuits (e.g., combinational or sequential logic circuits, memory circuits etc.).

The memory 415 (memory module) of the wearable device 404 may include any volatile, non-volatile, magnetic, or electrical media, such as a random access memory (RAM), read-only memory (ROM), non-volatile RAM (NVRAM), electrically-erasable programmable ROM (EEPROM), flash memory, or any other memory device. The memory 415 may store any of the data described herein. For example, the memory 415 may be configured to store data (e.g., motion data, temperature data, PPG data) collected by the respective sensors and PPG system 435. Furthermore, memory 415 may include instructions that, when executed by one or more processing circuits, cause the modules to perform various functions attributed to the modules herein. The device electronics of the wearable device 404 described herein are only example device electronics. As such, the types of electronic components used to implement the device electronics may vary based on design considerations.

The functions attributed to the modules of the wearable device 404 (e.g., wearable ring device) described herein may be embodied as one or more processors, hardware, firmware, software, or any combination thereof. Depiction of different features as modules is intended to highlight different functional aspects and does not necessarily imply that such modules must be realized by separate hardware/software components. Rather, functionality associated with one or more modules may be performed by separate hardware/software components or integrated within common hardware/software components.

The processing module 430-a of the wearable device 404 may include one or more processors (e.g., processing units), microcontrollers, digital signal processors, systems on a chip (SOCs), and/or other processing devices. The processing module 430-a communicates with the modules included in the wearable device 404. For example, the processing module 430-a may transmit/receive data to/from the modules and other components of the wearable device 404, such as the sensors. As described herein, the modules may be implemented by various circuit components. Accordingly, the modules may also be referred to as circuits (e.g., a communication circuit and power circuit).

The processing module 430-a may communicate with the memory 415. The memory 415 may include computer-readable instructions that, when executed by the processing module 430-a, cause the processing module 430-a to perform the various functions attributed to the processing module 430-a herein. In some implementations, the processing module 430-a (e.g., a microcontroller) may include additional features associated with other modules, such as communication functionality provided by the communication module 420-a (e.g., an integrated Bluetooth Low Energy transceiver) and/or additional onboard memory 415.

The communication module 420-a may include circuits that provide wireless and/or wired communication with the user device 406 (e.g., communication module 420-b of the user device 406). In some implementations, the communication modules 420-a, 420-b may include wireless communication circuits, such as Bluetooth circuits and/or Wi-Fi circuits. In some implementations, the communication modules 420-a, 420-b can include wired communication circuits, such as Universal Serial Bus (USB) communication circuits. Using the communication module 420-a, the wearable device 404 and the user device 406 may be configured to communicate with each other. The processing module 430-a of the ring may be configured to transmit/receive data to/from the user device 406 via the communication module 420-a. Example data may include, but is not limited to, motion data, temperature data, pulse waveforms, heart rate data, HRV data, PPG data, and status updates (e.g., charging status, battery charge level, and/or wearable device 404 configuration settings). The processing module 430-a of the ring may also be configured to receive updates (e.g., software/firmware updates) and data from the user device 406.

The wearable device 404 may include a battery 411 (e.g., a rechargeable battery 411). An example battery 411 may include a Lithium-Ion or Lithium-Polymer type battery 411, although a variety of battery 411 options are possible. The battery 411 may be wirelessly charged. In some implementations, the wearable device 404 may include a power source other than the battery 411, such as a capacitor. The power source (e.g., battery 411 or capacitor) may have a curved geometry that matches the curve of the wearable device 404. In some aspects, a charger or other power source may include additional sensors that may be used to collect data in addition to, or that supplements, data collected by the wearable device 404 itself. Moreover, a charger or other power source for the wearable device 404 may function as a user device 406, in which case the charger or other power source for the wearable device 404 may be configured to receive data from the wearable device 404, store and/or process data received from the wearable device 404, and communicate data between the wearable device 404 and the servers 410.

In some aspects, the wearable device 404 includes a power module 425 that may control charging of the battery 411. For example, the power module 425 may interface with an external wireless charger that charges the battery 411 when interfaced with the wearable device 404. The charger may include a datum structure that mates with a wearable device 404 datum structure to create a specified orientation with the wearable device 404 during charging. The power module 425 may also regulate voltage(s) of the device electronics, regulate power output to the device electronics, and monitor the state of charge of the battery 411. In some implementations, the battery 411 may include a protection circuit module (PCM) that protects the battery 411 from high current discharge, over voltage during charging, and under voltage during discharge. The power module 425 may also include electro-static discharge (ESD) protection.

The one or more temperature sensors 440 may be electrically coupled to the processing module 430-a. The temperature sensor 440 may be configured to generate a temperature signal (e.g., temperature data) that indicates a temperature read or sensed by the temperature sensor 440. The processing module 430-a may determine a temperature of the user in the location of the temperature sensor 440. For example, in the wearable device 404, temperature data generated by the temperature sensor 440 may indicate a temperature of a user at the user’s finger (e.g., skin temperature). In some implementations, the temperature sensor 440 may contact the user’s skin. In other implementations, a portion of the housing 405 (e.g., the inner housing 405-a) may form a barrier (e.g., a thin, thermally conductive barrier) between the temperature sensor 440 and the user’s skin. In some implementations, portions of the wearable device 404 configured to contact the user’s finger may have thermally conductive portions and thermally insulative portions. The thermally conductive portions may conduct heat from the user’s finger to the temperature sensors 440. The thermally insulative portions may insulate portions of the wearable device 404 (e.g., the temperature sensor 440) from ambient temperature.

In some implementations, the temperature sensor 440 may generate a digital signal (e.g., temperature data) that the processing module 430-a may use to determine the temperature. As another example, in cases where the temperature sensor 440 includes a passive sensor, the processing module 430-a (or a temperature sensor 440 module) may measure a current/voltage generated by the temperature sensor 440 and determine the temperature based on the measured current/voltage. Example temperature sensors 440 may include a thermistor, such as a negative temperature coefficient (NTC) thermistor, or other types of sensors including resistors, transistors, diodes, and/or other electrical/electronic components.

The processing module 430-a may sample the user’s temperature over time. For example, the processing module 430-a may sample the user’s temperature according to a sampling rate. An example sampling rate may include one sample per second, although the processing module 430-a may be configured to sample the temperature signal at other sampling rates that are higher or lower than one sample per second. In some implementations, the processing module 430-a may sample the user’s temperature continuously throughout the day and night. Sampling at a sufficient rate (e.g., one sample per second) throughout the day may provide sufficient temperature data for analysis described herein.

The processing module 430-a may store the sampled temperature data in memory 415. In some implementations, the processing module 430-a may process the sampled temperature data. For example, the processing module 430-a may determine average temperature values over a period of time. In one example, the processing module 430-a may determine an average temperature value each minute by summing all temperature values collected over the minute and dividing by the number of samples over the minute. In a specific example where the temperature is sampled at one sample per second, the average temperature may be a sum of all sampled temperatures for one minute divided by sixty seconds. The memory 415 may store the average temperature values over time. In some implementations, the memory 415 may store average temperatures (e.g., one per minute) instead of sampled temperatures in order to conserve memory 415.

The sampling rate, which may be stored in memory 415, may be configurable. In some implementations, the sampling rate may be the same throughout the day and night. In other implementations, the sampling rate may be changed throughout the day/night. In some implementations, the wearable device 404 may filter/reject temperature readings, such as large spikes in temperature that are not indicative of physiological changes (e.g., a temperature spike from a hot shower). In some implementations, the wearable device 404 may filter/reject temperature readings that may not be reliable due to other factors, such as excessive motion during exercise (e.g., as indicated by a motion sensor 445).

The wearable device 404 (e.g., communication module) may transmit the sampled and/or average temperature data to the user device 406 for storage and/or further processing. The user device 406 may transfer the sampled and/or average temperature data to the server 410 for storage and/or further processing.

Although the wearable device 404 is illustrated as including a single temperature sensor 440, the wearable device 404 may include multiple temperature sensors 440 in one or more locations, such as arranged along the inner housing 405-a near the user’s finger. In some implementations, the temperature sensors 440 may be stand-alone temperature sensors 440. Additionally, or alternatively, one or more temperature sensors 440 may be included with other components (e.g., packaged with other components), such as with the accelerometer and/or processor.

The processing module 430-a may acquire and process data from multiple temperature sensors 440 in a similar manner described with respect to a single temperature sensor 440. For example, the processing module 430 may individually sample, average, and store temperature data from each of the multiple temperature sensors 440. In other examples, the processing module 430-a may sample the sensors at different rates and average/store different values for the different sensors. In some implementations, the processing module 430-a may be configured to determine a single temperature based on the average of two or more temperatures determined by two or more temperature sensors 440 in different locations on the finger.

The temperature sensors 440 on the wearable device 404 (e.g., wearable ring device) may acquire distal temperatures at the user’s finger (e.g., any finger). For example, one or more temperature sensors 440 on the wearable device 404 may acquire a user’s temperature from the underside of a finger or at a different location on the finger. In some implementations, the wearable device 404 may continuously acquire distal temperature (e.g., at a sampling rate). Although distal temperature measured by a wearable device 404 at the finger is described herein, other devices may measure temperature at the same/different locations. In some cases, the distal temperature measured at a user’s finger may differ from the temperature measured at a user’s wrist or other external body location. Additionally, the distal temperature measured at a user’s finger (e.g., a “shell” temperature) may differ from the user’s core temperature. As such, the wearable device 404 may provide a useful temperature signal that may not be acquired at other internal/external locations of the body. In some cases, continuous temperature measurement at the finger may capture temperature fluctuations (e.g., small or large fluctuations) that may not be evident in core temperature. For example, continuous temperature measurement at the finger may capture minute-to-minute or hour-to-hour temperature fluctuations that provide additional insight that may not be provided by other temperature measurements elsewhere in the body.

The wearable device 404 may include a PPG system 435. The PPG system 435 may include one or more optical transmitters that transmit light. The PPG system 435 may also include one or more optical receivers that receive light transmitted by the one or more optical transmitters. An optical receiver may generate a signal (hereinafter “PPG” signal) that indicates an amount of light received by the optical receiver. The optical transmitters may illuminate a region of the user’s finger. The PPG signal generated by the PPG system 435 may indicate the perfusion of blood in the illuminated region. For example, the PPG signal may indicate blood volume changes in the illuminated region caused by a user’s pulse pressure. The processing module 430-a may sample the PPG signal and determine a user’s pulse waveform based on the PPG signal. The processing module 430-a may determine a variety of physiological parameters based on the user’s pulse waveform, such as a user’s respiratory rate, heart rate, HRV, oxygen saturation, and other circulatory parameters.

In some implementations, the PPG system 435 may be configured as a reflective PPG system 435 where the optical receiver(s) receive transmitted light that is reflected through the region of the user’s finger. In some implementations, the PPG system 435 may be configured as a transmissive PPG system 435 where the optical transmitter(s) and optical receiver(s) are arranged opposite to one another, such that light is transmitted directly through a portion of the user’s finger to the optical receiver(s).

The number and ratio of transmitters and receivers included in the PPG system 435 may vary. Example optical transmitters may include LEDs. The optical transmitters may transmit light in the infrared spectrum and/or other spectrums. Example optical receivers may include, but are not limited to, photosensors, phototransistors, and photodiodes. The optical receivers may be configured to generate PPG signals in response to the wavelengths received from the optical transmitters. The location of the transmitters and receivers may vary. Additionally, a single device may include reflective and/or transmissive PPG systems 435.

The PPG system 435 illustrated in FIG. 4 may include a reflective PPG system 435 in some implementations. In these implementations, the PPG system 435 may include a centrally located optical receiver (e.g., at the bottom of the wearable device 404) and two optical transmitters located on each side of the optical receiver. In this implementation, the PPG system 435 (e.g., optical receiver) may generate the PPG signal based on light received from one or both of the optical transmitters. In other implementations, other placements, combinations, and/or configurations of one or more optical transmitters and/or optical receivers are contemplated.

The processing module 430-a may control one or both of the optical transmitters to transmit light while sampling the PPG signal generated by the optical receiver. In some implementations, the processing module 430-a may cause the optical transmitter with the stronger received signal to transmit light while sampling the PPG signal generated by the optical receiver. For example, the selected optical transmitter may continuously emit light while the PPG signal is sampled at a sampling rate (e.g., 250 Hz).

Sampling the PPG signal generated by the PPG system 435 may result in a pulse waveform that may be referred to as a “PPG.” The pulse waveform may indicate blood pressure vs time for multiple cardiac cycles. The pulse waveform may include peaks that indicate cardiac cycles. Additionally, the pulse waveform may include respiratory induced variations that may be used to determine respiration rate. The processing module 430-a may store the pulse waveform in memory 415 in some implementations. The processing module 430-a may process the pulse waveform as it is generated and/or from memory 415 to determine user physiological parameters described herein.

The processing module 430-a may determine the user’s heart rate based on the pulse waveform. For example, the processing module 430-a may determine heart rate (e.g., in beats per minute) based on the time between peaks in the pulse waveform. The time between peaks may be referred to as an interbeat interval (IBI). The processing module 430-a may store the determined heart rate values and IBI values in memory 415.

The processing module 430-a may determine HRV over time. For example, the processing module 430-a may determine HRV based on the variation in the IBIs. The processing module 430-a may store the HRV values over time in the memory 415. Moreover, the processing module 430-a may determine the user’s respiratory rate over time. For example, the processing module 430-a may determine respiratory rate based on frequency modulation, amplitude modulation, or baseline modulation of the user’s IBI values over a period of time. Respiratory rate may be calculated in breaths per minute or as another breathing rate (e.g., breaths per 30 seconds). The processing module 430-a may store user respiratory rate values over time in the memory 415.

The wearable device 404 may include one or more motion sensors 445, such as one or more accelerometers (e.g., 6-D accelerometers) and/or one or more gyroscopes (gyros). The motion sensors 445 may generate motion signals that indicate motion of the sensors. For example, the wearable device 404 may include one or more accelerometers that generate acceleration signals that indicate acceleration of the accelerometers. As another example, the wearable device 404 may include one or more gyro sensors that generate gyro signals that indicate angular motion (e.g., angular velocity) and/or changes in orientation. The motion sensors 445 may be included in one or more sensor packages. An example accelerometer/gyro sensor is a Bosch BMI160 inertial micro electro-mechanical system (MEMS) sensor that may measure angular rates and accelerations in three perpendicular axes.

The processing module 430-a may sample the motion signals at a sampling rate (e.g., 50Hz) and determine the motion of the wearable device 404 based on the sampled motion signals. For example, the processing module 430-a may sample acceleration signals to determine acceleration of the wearable device 404. As another example, the processing module 430-a may sample a gyro signal to determine angular motion. In some implementations, the processing module 430-a may store motion data in memory 415. Motion data may include sampled motion data as well as motion data that is calculated based on the sampled motion signals (e.g., acceleration and angular values).

The wearable device 404 may store a variety of data described herein. For example, the wearable device 404 may store temperature data, such as raw sampled temperature data and calculated temperature data (e.g., average temperatures). As another example, wearable device 404 may store PPG signal data, such as pulse waveforms and data calculated based on the pulse waveforms (e.g., heart rate values, IBI values, HRV values, and respiratory rate values). The wearable device 404 may also store motion data, such as sampled motion data that indicates linear and angular motion.

The wearable device 404, or other computing device, may calculate and store additional values based on the sampled/calculated physiological data. For example, the processing module 430 may calculate and store various metrics, such as sleep metrics (e.g., a Sleep Score), activity metrics, and readiness metrics. In some implementations, additional values/metrics may be referred to as “derived values.” The wearable device 404, or other computing/wearable device, may calculate a variety of values/metrics with respect to motion. Example derived values for motion data may include, but are not limited to, motion count values, regularity values, intensity values, metabolic equivalence of task values (METs), and orientation values. Motion counts, regularity values, intensity values, and METs may indicate an amount of user motion (e.g., velocity/acceleration) over time. Orientation values may indicate how the wearable device 404 is oriented on the user’s finger and if the wearable device 404 is worn on the left hand or right hand.

In some implementations, motion counts and regularity values may be determined by counting a number of acceleration peaks within one or more periods of time (e.g., one or more 30 second to 1 minute periods). Intensity values may indicate a number of movements and the associated intensity (e.g., acceleration values) of the movements. The intensity values may be categorized as low, medium, and high, depending on associated threshold acceleration values. METs may be determined based on the intensity of movements during a period of time (e.g., 30 seconds), the regularity/irregularity of the movements, and the number of movements associated with the different intensities.

In some implementations, the processing module 430-a may compress the data stored in memory 415. For example, the processing module 430-a may delete sampled data after making calculations based on the sampled data. As another example, the processing module 430-a may average data over longer periods of time in order to reduce the number of stored values. In a specific example, if average temperatures for a user over one minute are stored in memory 415, the processing module 430-a may calculate average temperatures over a five minute time period for storage, and then subsequently erase the one minute average temperature data. The processing module 430-a may compress data based on a variety of factors, such as the total amount of used/available memory 415 and/or an elapsed time since the wearable device 404 last transmitted the data to the user device 406.

Although a user’s physiological parameters may be measured by sensors included on a wearable device 404, other devices may measure a user’s physiological parameters. For example, although a user’s temperature may be measured by a temperature sensor 440 included in a wearable device 404, other devices may measure a user’s temperature. In some examples, other wearable devices (e.g., wrist devices) may include sensors that measure user physiological parameters. Additionally, medical devices, such as external medical devices (e.g., wearable medical devices) and/or implantable medical devices, may measure a user’s physiological parameters. One or more sensors on any type of computing device may be used to implement the techniques described herein.

The physiological measurements may be taken continuously throughout the day and/or night. In some implementations, the physiological measurements may be taken during portions of the day and/or portions of the night. In some implementations, the physiological measurements may be taken in response to determining that the user is in a specific state, such as an active state, resting state, and/or a sleeping state. For example, the wearable device 404 can make physiological measurements in a resting/sleep state in order to acquire cleaner physiological signals. In one example, the wearable device 404 or other device/system may detect when a user is resting and/or sleeping and acquire physiological parameters (e.g., temperature) for that detected state. The devices/systems may use the resting/sleep physiological data and/or other data when the user is in other states in order to implement the techniques of the present disclosure.

In some implementations, as described previously herein, the wearable device 404 may be configured to collect, store, and/or process data, and may transfer any of the data described herein to the user device 406 for storage and/or processing. In some aspects, the user device 406 includes a wearable application 450, an operating system 485 (OS), a web browser application (e.g., web browser 480), one or more additional applications, and a GUI 475. The user device 406 may further include other modules and components, including sensors, audio devices, haptic feedback devices, and the like. The wearable application 450 may include an example of an application (e.g., “app”) that may be installed on the user device 406. The wearable application 450 may be configured to acquire data from the wearable device 404, store the acquired data, and process the acquired data as described herein. For example, the wearable application 450 may include a user interface (UI) module 455, an acquisition module 460, a processing module 430-b, a communication module 420-b, and a storage module (e.g., database 465) configured to store application data.

In some cases, the wearable device 404 and the user device 406 may be included within (or make up) the same device. For example, in some cases, the wearable device 404 may be configured to execute the wearable application 450, and may be configured to display data via the GUI 475.

The various data processing operations described herein may be performed by the wearable device 404, the user device 406, the servers 410, or any combination thereof. For example, in some cases, data collected by the wearable device 404 may be pre-processed and transmitted to the user device 406. In this example, the user device 406 may perform some data processing operations on the received data, may transmit the data to the servers 410 for data processing, or both. For instance, in some cases, the user device 406 may perform processing operations that require relatively low processing power and/or operations that require a relatively low latency, whereas the user device 406 may transmit the data to the servers 410 for processing operations that require relatively high processing power and/or operations that may allow relatively higher latency.

In some aspects, the wearable device 404 (e.g., wearable ring device), user device 406, and server 410 of the system 400 may be configured to evaluate sleep patterns for a user. In particular, the respective components of the system 400 may be used to collect data from a user via the wearable device 404, and generate one or more scores (e.g., Sleep Score, Readiness Score) for the user based on the collected data. For example, as noted previously herein, the wearable device 404 of the system 400 may be worn by a user to collect data from the user, including temperature, heart rate, HRV, and the like. Data collected by the wearable device 404 may be used to determine when the user is asleep in order to evaluate the user’s sleep for a given “sleep day.” In some aspects, scores may be calculated for the user for each respective sleep day, such that a first sleep day is associated with a first set of scores, and a second sleep day is associated with a second set of scores. Scores may be calculated for each respective sleep day based on data collected by the wearable device 404 during the respective sleep day. Scores may include, but are not limited to, Sleep Scores, Readiness Scores, and the like.

In some cases, “sleep days” may align with the traditional calendar days, such that a given sleep day runs from midnight to midnight of the respective calendar day. In other cases, sleep days may be offset relative to calendar days. For example, sleep days may run from 6:00 pm (18:00) of a calendar day until 6:00 pm (18:00) of the subsequent calendar day. In this example, 6:00 pm may serve as a “cut-off time,” where data collected from the user before 6:00 pm is counted for the current sleep day, and data collected from the user after 6:00 pm is counted for the subsequent sleep day. Due to the fact that most individuals sleep the most at night, offsetting sleep days relative to calendar days may enable the system 400 to evaluate sleep patterns for users in such a manner that is consistent with their sleep schedules. In some cases, users may be able to selectively adjust (e.g., via the GUI) a timing of sleep days relative to calendar days so that the sleep days are aligned with the duration of time that the respective users typically sleep.

In some implementations, each overall score for a user for each respective day (e.g., Sleep Score, Readiness Score) may be determined/calculated based on one or more “contributors,” “factors,” or “contributing factors.” For example, a user’s overall Sleep Score may be calculated based on a set of contributors, including: total sleep, efficiency, restfulness, REM sleep, deep sleep, latency, timing, or any combination thereof. The Sleep Score may include any quantity of contributors. The “total sleep” contributor may refer to the sum of all sleep periods of the sleep day. The “efficiency” contributor may reflect the percentage of time spent asleep compared to time spent awake while in bed, and may be calculated using the efficiency average of long sleep periods (e.g., primary sleep period) of the sleep day, weighted by a duration of each sleep period. The “restfulness” contributor may indicate how restful the user’s sleep is, and may be calculated using the average of all sleep periods of the sleep day, weighted by a duration of each period. The restfulness contributor may be based on a “wake up count” (e.g., sum of all the wake-ups (when user wakes up) detected during different sleep periods), excessive movement, and a “got up count” (e.g., sum of all the got-ups (when user gets out of bed) detected during the different sleep periods).

The “REM sleep” contributor may refer to a sum total of REM sleep durations across all sleep periods of the sleep day including REM sleep. Similarly, the “deep sleep” contributor may refer to a sum total of deep sleep durations across all sleep periods of the sleep day including deep sleep. The “latency” contributor may signify how long (e.g., average, median, longest) the user takes to go to sleep, and may be calculated using the average of long sleep periods throughout the sleep day, weighted by a duration of each period and the number of such periods (e.g., consolidation of a given sleep stage or sleep stages may be its own contributor or weight other contributors). Lastly, the “timing” contributor may refer to a relative timing of sleep periods within the sleep day and/or calendar day, and may be calculated using the average of all sleep periods of the sleep day, weighted by a duration of each period.

By way of another example, a user’s overall Readiness Score may be calculated based on a set of contributors, including: sleep, sleep balance, heart rate, HRV balance, recovery index, temperature, activity, activity balance, or any combination thereof. The Readiness Score may include any quantity of contributors. The “sleep” contributor may refer to the combined Sleep Score of all sleep periods within the sleep day. The “sleep balance” contributor may refer to a cumulative duration of all sleep periods within the sleep day. In particular, sleep balance may indicate to a user whether the sleep that the user has been getting over some duration of time (e.g., the past two weeks) is in balance with the user’s needs. Typically, adults need 7–9 hours of sleep a night to stay healthy, alert, and to perform at their best both mentally and physically. However, it is normal to have an occasional night of bad sleep, so the sleep balance contributor takes into account long-term sleep patterns to determine whether each user’s sleep needs are being met. The “resting heart rate” contributor may indicate a lowest heart rate from the longest sleep period of the sleep day (e.g., primary sleep period) and/or the lowest heart rate from naps occurring after the primary sleep period.

Continuing with reference to the “contributors” (e.g., factors, contributing factors) of the Readiness Score, the “HRV balance” contributor may indicate a highest HRV average from the primary sleep period and the naps happening after the primary sleep period. The HRV balance contributor may help users keep track of their recovery status by comparing their HRV trend over a first time period (e.g., two weeks) to an average HRV over some second, longer time period (e.g., three months). The “recovery index” contributor may be calculated based on the longest sleep period. Recovery index measures how long it takes for a user’s resting heart rate to stabilize during the night. A sign of a very good recovery is that the user’s resting heart rate stabilizes during the first half of the night, at least six hours before the user wakes up, leaving the body time to recover for the next day. The “body temperature” contributor may be calculated based on the longest sleep period (e.g., primary sleep period) or based on a nap happening after the longest sleep period if the user’s highest temperature during the nap is at least 0.5°C higher than the highest temperature during the longest period. In some aspects, the ring may measure a user’s body temperature while the user is asleep, and the system 400 may display the user’s average temperature relative to the user’s baseline temperature. If a user’s body temperature is outside of their normal range (e.g., clearly above or below 0.0), the body temperature contributor may be highlighted (e.g., go to a “Pay attention” state) or otherwise generate an alert for the user.

It should be noted that the methods described above describe possible implementations, and that the operations and the steps may be rearranged or otherwise modified and that other implementations are possible. Furthermore, aspects from two or more of the methods may be combined.

The following provides an overview of aspects of the present disclosure:

Aspect 1: A wearable ring device, comprising: an outer housing; an inner housing; a flexible component positioned at least partially within an aperture in the inner housing, wherein at least a portion of the flexible component extends beyond a surface of the inner housing; one or more magnets coupled with the flexible component; one or more coils positioned between the outer housing and the flexible component, wherein the flexible component is configured to deform in a first radial direction in response to a first magnetic force generated between the one or more coils and the one or more magnets when the one or more coils operate in a first mode; and circuitry electrically coupled with the one or more coils and configured to detect changes in voltage of the one or more coils in response to the flexible component deforming in a second radial direction, opposite the first radial direction, when the one or more coils operate in a second mode.

Aspect 2: The wearable ring device of aspect 1, wherein the one or more coils are capable of operating in both the first mode and the second mode.

Aspect 3: The wearable ring device of aspect 2, wherein the one or more coils are configured to operate in either the first mode or the second mode at a given time.

Aspect 4: The wearable ring device of any of aspects 1 through 3, wherein the one or more coils comprise one or more driver coils configured to operate in the first mode, wherein the flexible component is configured to deform in the first radial direction in response to the first magnetic force generated between the one or more driver coils and the one or more magnets; and one or more detector coils configured to operate in the second mode, wherein the circuitry is configured to detect changes in the voltage of the one or more driver coils in response to the flexible component deforming in the second radial direction.

Aspect 5: The wearable ring device of aspect 4, wherein the one or more driver coils are configured to remain inactive when the one or more detector coils are active, and the one or more detector coils are configured to remain inactive when the one or more driver coils are active.

Aspect 6: The wearable ring device of any of aspects 4 through 5, wherein the one or more driver coils are offset from the one or more detector coils in accordance with a threshold offset.

Aspect 7: The wearable ring device of any of aspects 1 through 6, wherein the circuitry electrically coupled with the one or more coils is configured to generate a current through the one or more coils in accordance with one or more parameters, wherein the first magnetic force is based at least in part on the current, and wherein the one or more parameters are associated with a first feedback pattern of a plurality of feedback patterns.

Aspect 8: The wearable ring device of aspect 7, wherein the one or more parameters comprise a frequency of the current, a waveform of the current, a voltage of the current, or any combination thereof.

Aspect 9: The wearable ring device of any of aspects 7 through 8, wherein each feedback pattern of the plurality of feedback patterns is associated with a respective set of one or more parameters.

Aspect 10: The wearable ring device of any of aspects 7 through 9, wherein the circuitry electrically coupled with the one or more coils is configured to generate a second current through the one or more coils in accordance with one or more second parameters, wherein a second magnetic force generated between the one or more coils and the one or more magnets is based at least in part on the second current, and wherein the one or more second parameters are associated with a second feedback pattern of the plurality of feedback patterns, different than the first feedback pattern.

Aspect 11: The wearable ring device of aspect 10, wherein the first feedback pattern is associated with a first type of feedback and the second feedback pattern is associated with a second type of feedback, and the second feedback pattern is different than the first feedback pattern based at least in part on the second type of feedback being different than the first type of feedback.

Aspect 12: The wearable ring device of any of aspects 1 through 11, wherein the flexible component comprises one or more cavities, and the one or more magnets are positioned at least partially within the one or more cavities.

Aspect 13: The wearable ring device of any of aspects 1 through 12, further comprising one or more sensors configured to measure physiological data from a user in accordance with one or more operational parameters, wherein the one or more operational parameters are based at least in part on the changes in the voltage of the one or more coils.

Aspect 14: The wearable ring device of any of aspects 1 through 13, wherein a length of the portion of the flexible component that extends beyond the surface of the inner housing, an elasticity of the flexible component, or both, is based at least in part on a size of the wearable ring device.

Aspect 15: The wearable ring device of any of aspects 1 through 14, further comprising a flexible printed circuit board positioned between the inner housing and the outer housing, wherein the one or more coils are electrically coupled with the flexible printed circuit board.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A wearable ring device, comprising:
an outer housing;
an inner housing;
a flexible component positioned at least partially within an aperture in the inner housing, wherein at least a portion of the flexible component extends beyond a surface of the inner housing;
one or more magnets coupled with the flexible component;
one or more coils positioned between the outer housing and the flexible component, wherein the flexible component is configured to deform in a first radial direction in response to a first magnetic force generated between the one or more coils and the one or more magnets when the one or more coils operate in a first mode; and
circuitry electrically coupled with the one or more coils and configured to detect changes in voltage of the one or more coils in response to the flexible component deforming in a second radial direction, opposite the first radial direction, when the one or more coils operate in a second mode.

2. The wearable ring device of claim 1, wherein the one or more coils are capable of operating in both the first mode and the second mode.

3. The wearable ring device of claim 2, wherein the one or more coils are configured to operate in either the first mode or the second mode at a given time.

4. The wearable ring device of claim 1, wherein the one or more coils comprise:
one or more driver coils configured to operate in the first mode, wherein the flexible component is configured to deform in the first radial direction in response to the first magnetic force generated between the one or more driver coils and the one or more magnets; and
one or more detector coils configured to operate in the second mode, wherein the circuitry is configured to detect changes in the voltage of the one or more driver coils in response to the flexible component deforming in the second radial direction.

5. The wearable ring device of claim 4, wherein the one or more driver coils are configured to remain inactive when the one or more detector coils are active, and the one or more detector coils are configured to remain inactive when the one or more driver coils are active.

6. The wearable ring device of claim 4, wherein the one or more driver coils are offset from the one or more detector coils in accordance with a threshold offset.

7. The wearable ring device of claim 1, wherein the circuitry electrically coupled with the one or more coils is configured to:
generate a current through the one or more coils in accordance with one or more parameters, wherein the first magnetic force is based at least in part on the current, and wherein the one or more parameters are associated with a first feedback pattern of a plurality of feedback patterns.

8. The wearable ring device of claim 7, wherein the one or more parameters comprise a frequency of the current, a waveform of the current, a voltage of the current, or any combination thereof.

9. The wearable ring device of claim 7, wherein each feedback pattern of the plurality of feedback patterns is associated with a respective set of one or more parameters.

10. The wearable ring device of claim 7, wherein the circuitry electrically coupled with the one or more coils is configured to:
generate a second current through the one or more coils in accordance with one or more second parameters, wherein a second magnetic force generated between the one or more coils and the one or more magnets is based at least in part on the second current, and wherein the one or more second parameters are associated with a second feedback pattern of the plurality of feedback patterns, different than the first feedback pattern.

11. The wearable ring device of claim 10, wherein the first feedback pattern is associated with a first type of feedback and the second feedback pattern is associated with a second type of feedback, and wherein the second feedback pattern is different than the first feedback pattern based at least in part on the second type of feedback being different than the first type of feedback.

12. The wearable ring device of claim 1, wherein the flexible component comprises one or more cavities, wherein the one or more magnets are positioned at least partially within the one or more cavities.

13. The wearable ring device of claim 1, further comprising:
one or more sensors configured to measure physiological data from a user in accordance with one or more operational parameters, wherein the one or more operational parameters are based at least in part on the changes in the voltage of the one or more coils.

14. The wearable ring device of claim 1, wherein a length of the portion of the flexible component that extends beyond the surface of the inner housing, an elasticity of the flexible component, or both, is based at least in part on a size of the wearable ring device.

15. The wearable ring device of claim 1, further comprising:
a flexible printed circuit board positioned between the inner housing and the outer housing, wherein the one or more coils are electrically coupled with the flexible printed circuit board.
